(19) United States
(12) Patent Application Publication
(10) Pub. No.: US 2023/0170975 A1
(43) Pub. Date: Jun. 1, 2023

(54) COMBINATION OF UPSTREAM-PROCESSED SIGNALS FROM INDEPENDENT RECEIVER SUBARRAYS

(71) Applicant: Telefonaktiebolaget LM Ericsson (publ), Stockholm (SE)

(72) Inventor: Ali S. Khayrallah, MOUNTAIN VIEW, CA (US)

(21) Appl. No.: 17/921,889

(22) PCT Filed: May 4, 2020
(86) PCT No.: PCT/IB2020/054220

§ 371 Date: Oct. 27, 2022

(51) Int. Cl. H04B 7/08

(52) U.S. Cl. CPC H04B 7/0874

(57) ABSTRACT

A method of operating a network node of a communication network is provided. The method includes receiving, by processing circuitry of the network node, a first upstream-processed signal associated with an original signal. The method further includes receiving, by the processing circuitry in the network node, a second upstream-processed signal, associated with the original signal. The method further includes determining, by the processing circuitry in the network node, a covariance associated with the first upstream-processed signal and the second upstream-processed signal. The method further includes obtaining, by the processing circuitry in the network node, a processed received signal based on the first upstream-processed signal, the second upstream-processed signal, and the covariance.

### TECHNICAL FIELD

The present disclosure relates generally to network nodes in wireless communication networks and more specifically to receiver subarray cooperation in downstream receiver processing circuitry.

### BACKGROUND

Technology advances, capacity demands, and higher frequency operation have led to a rise in the number of base station receive antennas and radio-near processing. Receiver antenna arrays are partitioned into subarrays, each with their own independent and dedicated processing circuitry.

### SUMMARY

According to some embodiments, a method of operating a network node a communication network is provided. The method includes receiving, by processing circuitry of the network node, a first upstream-processed signal associated with an original signal. The method further includes receiving, by the processing circuitry in the network node, a second upstream-processed signal, associated with the original signal. The method further includes determining, by the processing circuitry in the network node, a covariance associated with the first upstream-processed signal and the second upstream-processed signal. The method further includes obtaining, by the processing circuitry in the network node, a processed received signal based on the first upstream-processed signal, the second upstream-processed signal, and the covariance.

According to other embodiments, a network node operating in a communication network is provided. The network node includes processing circuitry and memory coupled to the processing circuitry. The memory has instructions stored therein that are executable by the processing circuitry to cause the network node to perform operations. The operations include receiving, by processing circuitry of the network node, a first upstream-processed signal associated with an original signal. The operations further include receiving, by the processing circuitry in the network node, a second upstream-processed signal, associated with the original signal. The operations further include determining, by the processing circuitry in the network node, a covariance associated with the first upstream-processed signal and the second upstream-processed signal. The operations further include obtaining, by the processing circuitry in the network node, a processed received signal based on the first upstream-processed signal, the second upstream-processed signal, and the covariance.

According to other embodiments, a network node operating in a communication network and adapted to perform operations is provided. The operations include receiving, by processing circuitry of the network node, a first upstream-processed signal associated with an original signal. The operations further include receiving, by the processing circuitry in the network node, a second upstream-processed signal, associated with the original signal. The operations further include determining, by the processing circuitry in the network node, a covariance associated with the first upstream-processed signal and the second upstream-processed. The operations further include obtaining, by the processing circuitry in the network node, a processed received signal based on the first upstream-processed signal, the second upstream-processed signal, and covariance.

According to other embodiments, a computer program is provided. The computer program includes program code to be executed by processing circuitry of a network node operating in a communication network, whereby execution of the program code causes the network node to perform operations. The operations include receiving, by processing circuitry of the network node, a first upstream-processed signal associated with an original signal. The operations further include receiving, by the processing circuitry in the network node, a second upstream-processed signal, associated with the original signal. The operations further include determining, by the processing circuitry in the network node, a covariance associated with the first upstream-processed signal and the second upstream-processed signal. The operations further include obtaining, by the processing circuitry in the network node, a processed received signal based on the first upstream-processed signal, the second upstream-processed signal, and the covariance.

According to other embodiments, a computer program product is provided. The computer program product includes a non-transitory storage medium including program code to be executed by processing circuitry of a network node operating in a communication network, whereby execution of the program code causes the network node to perform operations. The operations include receiving, by processing circuitry of the network node, a first upstream-processed signal associated with an original signal. The operations further include receiving, by the processing circuitry in the network node, a second upstream-processed signal, associated with the original signal. The operations further include determining, by the processing circuitry in the network node, a covariance associated with the first upstream-processed signal and the second upstream-processed signal. The operations further include obtaining, by the processing circuitry in the network node, a processed received signal based on the first upstream-processed signal, the second upstream-processed signal, and the covariance.

In various embodiments described herein, processing architecture and algorithms for a receiver with multiple subarrays is described with parts of the processing occurring at each subarray, and another part occurring downstream fed by the subarrays. Combining the up-stream processed signals by downstream processing circuitry results in overall receiver performance that approaches that of a full array with unrestricted processing.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a block diagram illustrating an example of a receiver structure with parameter estimation, parameter transform, signal transform, and a search unit;

FIG. 2 is a block diagram illustrating an example of a constrained processing structure with two subarrays, two upstream processing circuitry, and one downstream processing in accordance with some embodiments;

FIG. 3 is a block diagram illustrating an example of different domains of a receiver in accordance with some embodiments;

FIG. 4 is a block diagram illustrating an example of a subarray processing structure for a first receive signal, r_{A}, in accordance with some embodiments;

FIG. 5 is a block diagram illustrating an example of a subarray processing structure for a second receive signal, r_{B}, in accordance with some embodiments;

FIG. 6 is a block diagram illustrating an example of a downstream processing structure for a first upstream-processed signal, \tilde{s}_{A}, and a second upstream-processed signal, \tilde{s}_{B}, in accordance with some embodiments;

FIG. 7 is a block diagram illustrating an example of a communication device in accordance with some embodiments;

FIG. 8 is a block diagram illustrating an example of a radio access network (“RAN”) node in accordance with some embodiments;

FIG. 9 is a block diagram illustrating an example of a core network (“CN”) node in accordance with some embodiments;

FIG. 10 is a block diagram illustrating an example of a RAN node with antenna subarrays and upstream processors in accordance with some embodiments; and

FIG. 11 is a flow chart illustrating an example of a process performed by a network node in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Constrained processing per subarray can result in performance loss compared to unconstrained processing with the full array, which may prevent the array investment being fully exploited.

Various embodiments described herein propose a process for subarray cooperation, so that overall receiver performance approaches that of a full array with unrestricted processing. The subarrays produce outcomes including appropriate information, and those outcomes are then further processed together downstream.

Some embodiments do not violate the constrained architecture, in the sense that some embodiments do not require any direct communication among subarrays or any feedback to the subarrays. The combination of subarray output and downstream processing results in performance close to that of the unrestricted full array receiver.

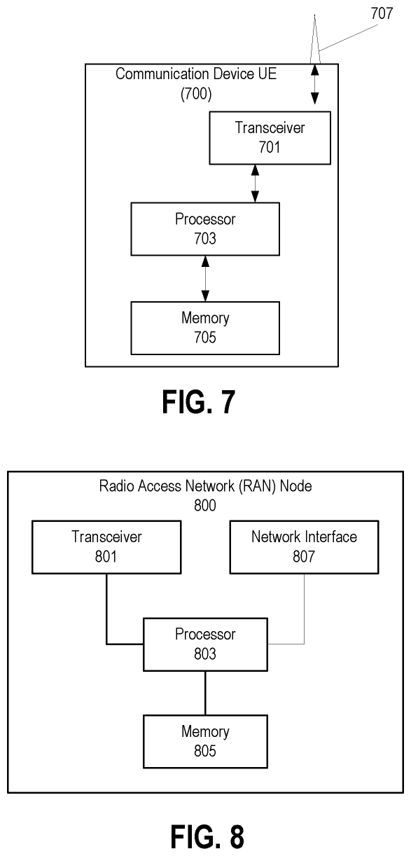

FIG. 7 is a block diagram illustrating elements of a communication device UE 700 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. As shown, communication device UE may include an antenna 707, and transceiver circuitry 701 including a transmitter and a receiver configured to provide uplink and downlink radio communications with a base station(s), also referred to as a RAN node) of a radio access network. Communication device UE may also include processing circuitry 703 coupled to the transceiver circuitry, and memory circuitry 705 (also referred to as memory) coupled to the processing circuitry. The memory circuitry 705 may include computer readable program code that when executed by the processing circuitry 703 causes the processing circuitry to perform operations according to embodiments disclosed herein. According to other embodiments, processing circuitry 703 may be defined to include memory so that separate memory circuitry is not required. Communication device UE may also include an interface (such as a user interface) coupled with processing circuitry 703, and/or communication device UE may be incorporated in a vehicle.

As discussed herein, operations of communication device UE may be performed by processing circuitry 703 and/or transceiver circuitry 701. For example, processing circuitry 703 may control transceiver circuitry 701 to transmit communications through transceiver circuitry 701 over a radio interface to a radio access network node (also referred to as a base station) and/or to receive communications through transceiver circuitry 701 from a RAN node over a radio interface. Moreover, modules may be stored in memory circuitry 705, and these modules may provide instructions so that when instructions of a module are executed by processing circuitry 703, processing circuitry 703 performs respective operations (e.g., operations discussed below with respect to Example Embodiments relating to wireless communication devices).

FIG. 8 is a block diagram illustrating elements of a radio access network RAN node 800 (also referred to as a network node, base station, eNodeB/eNB (Evolved Node B), gNodeB/gNB, etc.) of a Radio Access Network (RAN) configured to provide cellular communication according to embodiments of inventive concepts. As shown, the RAN node may include transceiver circuitry 801 (also referred to as a transceiver) including a transmitter and a receiver configured to provide uplink and downlink radio communications with mobile terminals. The RAN node may include network interface circuitry 807 (also referred to as a network interface) configured to provide communications with other nodes (e.g., with other base stations) of the RAN and/or core network CN. The network node may also include processing circuitry 803 (also referred to as a processor, e.g., corresponding to processing circuitry 4170) coupled to the transceiver circuitry, and memory circuitry 805 (also referred to as memory) coupled to the processing circuitry. The memory circuitry 805 may include computer readable program code that when executed by the processing circuitry 803 causes the processing circuitry to perform operations according to embodiments disclosed herein. According to other embodiments, processing circuitry 803 may be defined to include memory so that a separate memory circuitry is not required.

As discussed herein, operations of the RAN node may be performed by processing circuitry 803, network interface 807, and/or transceiver 801. For example, processing circuitry 803 may control transceiver 801 to transmit downlink communications through transceiver 801 over a radio interface to one or more mobile terminals UEs and/or to receive uplink communications through transceiver 801 from one or more mobile terminals UEs over a radio interface. Similarly, processing circuitry 803 may control network interface 807 to transmit communications through network interface 807 to one or more other network nodes and/or to receive communications through network interface from one or more other network nodes. Moreover, modules may be stored in memory 805, and these modules may provide instructions so that when instructions of a module are executed by processing circuitry 803, processing circuitry 803 performs respective operations (e.g., operations discussed below with respect to Example Embodiments relating to RAN nodes).

According to some other embodiments, a network node may be implemented as a core network CN node without a wireless transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

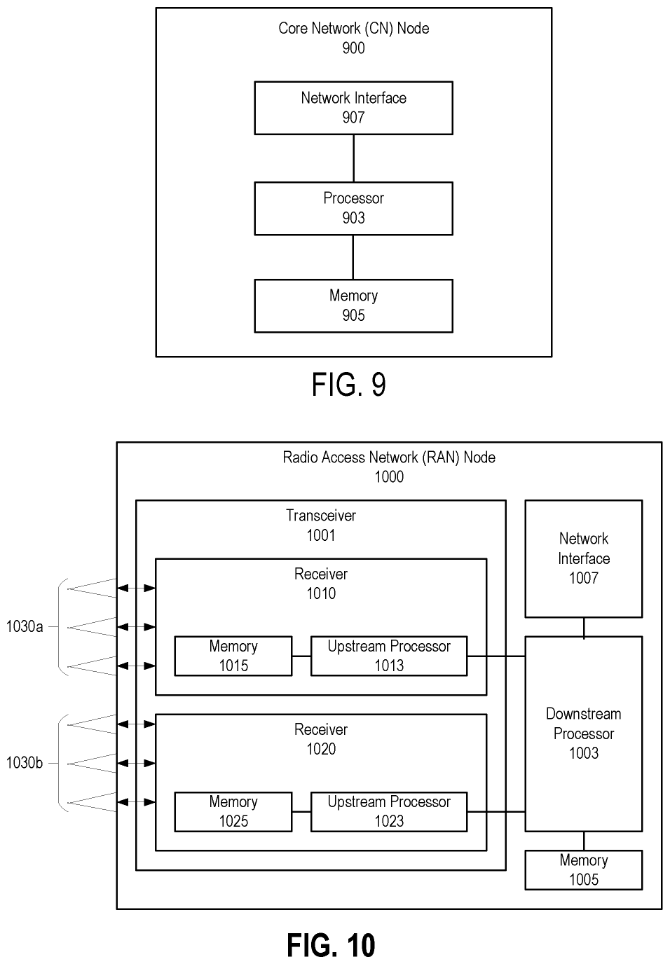

FIG. 9 is a block diagram illustrating elements of a core network CN node (e.g., an Session Management Function (“SMF”) node, an Access and Mobility Management Function (“AMF”) node, etc.) of a communication network configured to provide cellular communication according to embodiments of inventive concepts. As shown, the CN node may include network interface circuitry 907 (also referred to as a network interface) configured to provide communications with other nodes of the core network and/or the radio access network RAN. The CN node may also include a processing circuitry 903 (also referred to as a processor) coupled to the network interface circuitry, and memory circuitry 905 (also referred to as memory) coupled to the processing circuitry. The memory circuitry 905 may include computer readable program code that when executed by the processing circuitry 903 causes the processing circuitry to perform operations according to embodiments disclosed herein. According to other embodiments, processing circuitry 903 may be defined to include memory so that a separate memory circuitry is not required.

As discussed herein, operations of the CN node may be performed by processing circuitry 903 and/or network interface circuitry 907. For example, processing circuitry 903 may control network interface circuitry 907 to transmit communications through network interface circuitry 907 to one or more other network nodes and/or to receive communications through network interface circuitry from one or more other network nodes. Moreover, modules may be stored in memory 905, and these modules may provide instructions so that when instructions of a module are executed by processing circuitry 903, processing circuitry 903 performs respective operations (e.g., operations discussed below with respect to Example Embodiments relating to core network nodes).

FIG. 10 is a block diagram illustrating elements of another radio access network, RAN, node 1000 (also referred to as a network node, base station, eNodeB/eNB, gNodeB/gNB, etc.) of a Radio Access Network (RAN) configured to provide cellular communication according to embodiments of inventive concepts. As shown, the RAN node may include transceiver circuitry 1001 (also referred to as a transceiver) including a transmitter and a receiver configured to provide uplink and downlink radio communications with mobile terminals. Here, transceiver 1001 is depicted as including a pair of receivers 1010, 1020 each with their own upstream processing circuitry 1013, 1023 (also referred to as upstream processors) and corresponding memory circuitry 1015, 1025 (also referred to as memory). The memory circuitry 1015, 1025 may include computer readable program code that when executed by the upstream processing circuitry 1013, 1023 causes the upstream processing circuitry to perform operations according to embodiments disclosed herein. For example, upstream processing circuitry 1013, 1023 may transform receive signal domain representations of signals received via antenna subarrays 1030a, 1030b into transmit domain representations. According to other embodiments, upstream processing circuitry 1013, 1023 may be defined to include memory so that a separate memory circuitry is not required. The RAN node 1000 may include or be coupled to an array of antenna that are made up of one or more antenna subarrays. Here, receiver 1010 is associated with antenna subarray 1030a and receiver 1020 is associated with antenna subarray 1030b.

The RAN node may include network interface circuitry 1007 (also referred to as a network interface) configured to provide communications with other nodes (e.g., with other base stations) of the RAN and/or core network CN. The network node may also include downstream processing circuitry 1003 (also referred to as a processor, e.g., corresponding to processing circuitry 4170) coupled to the transceiver circuitry, and memory circuitry 1005 (also referred to as memory) coupled to the processing circuitry. The memory circuitry 1005 may include computer readable program code that when executed by the downstream processing circuitry 1003 causes the downstream processing circuitry 1003 to perform operations according to embodiments disclosed herein. For example, downstream processing circuitry may combine outputs from receivers 1010, 1020. According to other embodiments, downstream processing circuitry 1003 may be defined to include memory so that a separate memory circuitry is not required. Modules may be stored in memory 1005, and these modules may provide instructions so that when instructions of a module are executed by processing circuitry 1003, 1013, 1023, processing circuitry 1003, 1013, 1023, performs respective operations. In additional or alternative embodiments, another network node (e.g., a UE or a CN node) may have multiple receivers similar to receiver 1010, 1020 that are each associated with an antenna subarray and a downstream processor for performing similar operations as RAN node 1000.

In some embodiments, a MIMO system is provided in which the transmitter sends M streams and the receiver has N antennas. In some examples, linear receiver techniques are used which assume that N M. Furthermore, since the antennas are split into subsets, the size of each subset M. The following disclosure describes embodiments in which the array is split into two subsets of equal size (N/2) and that N/2≥M. However, the subarrays may be of inequal size and the array may be divided into any number of subarrays.

In some embodiments, a system equation for describing a vector, r, of received symbols is given by

r=Hs+w

where s is a vector of M symbols from a modulation constellation (e.g., QAM) and H is a channel matrix of size N×M. In some examples, the channels have an average energy of one. The total noise, w, can include an interference signal plus a white noise signal,

w=Hᵢsᵢ+v

The total noise covariance of size N×N can be written as

R_{w}=EᵢHᵢHᵢ^{H}+EᵥI

where Eᵢ and Eᵥ are the interference and white noise energy, respectively. Channel parameters can be estimated from the received signal, aided by pilot symbols embedded in transmitted signals.

A maximum likelihood (ML) demodulator can search for a candidate vectors for s that minimizes the metric:

m(ŝ)=(r−Hŝ)^{H}R_{w}⁻¹(r−Hŝ)

This may require a full search, which can become infeasible for a large constellation or a large number of streams.

In some embodiments, in order to facilitate downstream processing, a receive signal domain representation of the receive signal can be transformed to a transmit signal domain representation, along the lines of a sphere decoder (SD). A SD can search among the candidate transmit signals \tilde{s} within a progressively shrinking sphere centered at an initial guess \tilde{s}. Overall, the SD can be computationally efficient while remaining equivalent to the ML demodulator. Various shortcuts can further speed up the SD, with corresponding performance penalties.

A receive signal domain representation can be transformed to a transmit domain representation using a left inverse F of H, of size M×N, given by:

F=(H^{H}R_{w}⁻¹H)⁻¹H^{H}R_{w}⁻¹

The received signal, r, can be transformed into

\tilde{s}=Fr

where \tilde{s} is the ML estimate of s, if s were a Gaussian vector. Since s belongs to a discrete set, \tilde{s} can be an initial guess for s. The candidates of \tilde{s} can be searched in the neighborhood of ŝ for the final answer. \tilde{s} can be written as

\tilde{s}=s+x

where x=Fw with covariance:

Rₓ=FR_{W}F^{H}

of size M×M, which can be written as

Rₓ=(H^{H}R_{w}⁻¹H)⁻¹

In some embodiments, given \tilde{s}, the SD finds the best candidate using a modified metric given by:

n(ŝ)=(\tilde{s}−ŝ)^{H}Rₓ⁻¹(\tilde{s}−ŝ)

The SD can exploit the Hermitian (complex symmetric) property of the covariance matrix. It can perform a Cholesky decomposition, which computes a triangular “root” matrix K such that:

K^{H}K=Rₓ⁻¹

The triangular property can enable the solution of linear systems by back substitution. It is also an ingredient in facilitating the restriction of the search to a sphere. We refer to finding the best candidate using n(ŝ) under the sphere restriction as the sphere restricted search.

In some embodiments, in addition to the modulation symbols, a demapper can use the metrics of the SD to produce hard and soft values for the modem bits that map into the modulation symbols. The hard or soft bit values can be fed to the channel decoder.

In some embodiments, channel estimates can be computed by using pilot symbols. Note that matrix inverses appear on several occasions. In practice, except for very small dimensions, they can be approximated using well known numerical methods. In some embodiments, a covariance matrix can be estimated from received data. In additional or alternative embodiments, a square root of the covariance can be computed directly.

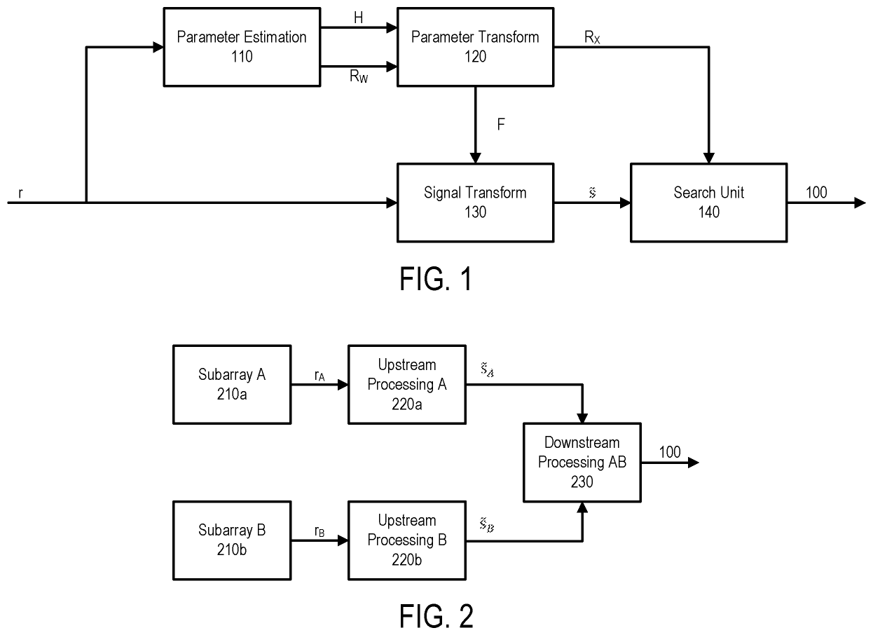

FIG. 1 illustrates a baseline process that includes parameter estimation 110, the parameter transform 120 to obtain F and Rₓ, the signal transform 130 from the receive domain to the transmit domain, and a search unit 140 (e.g., a sphere restricted search unit).

Various embodiments herein are illustrated by the structure in FIG. 2. In this example, two subarrays (subarray A 210a and subarray B 210b) each receive a signal (r_{A} and r_{B} respectively). Each of subarrays 210a, 210b are associated with upstream processing circuitry (upstream processing A 220a and upstream processing B 220b respectively), which process the received signal into a transmit domain representation of the received signal (\tilde{s}_{A} and \tilde{s}_{B} below). A downstream processing circuitry 230 determines a processed received signal 100 based on the transmit domain representations of the received signals.

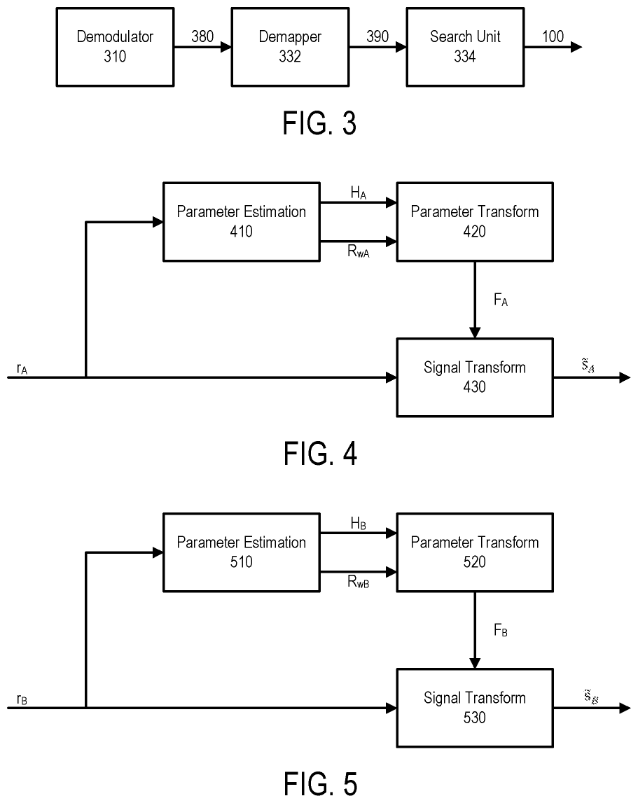

FIG. 3 illustrates different domains of a receiver and their place in the receive chain. In some embodiments, downstream processing circuitry can include the search unit 334 (e.g. a decoder) and process the output 390 of the demapper 332 of a subarray receiver. The output 390 can include modem hard or soft bits. In some embodiments, the downstream processing circuitry can include the demapper 332 and the search unit 334 and uses output of the demodulator 310 of a subarray receiver, the output 380 being a transmit signal domain representation of a receive signal received via a subarray of the antenna array. The interference structure can appear tractable in this domain. The demapper 332 of a subarray receiver can cause irreversible upstream processing that results in a loss of information about the interference structure due to the demapper 332 transformation.

In additional or alternative embodiments, all the N antennas see independent channels. The full array receiver will then capture all the channel diversity, whereas the individual subarray receivers will only capture their limited share. However, it is possible to recover the full diversity by appropriately combining subarray outputs using downstream processing circuitry.

In additional or alternative embodiments, interference suppression is a more difficult problem with subarrays. The interference can be treated as colored noise with covariance Rₓ and can be suppressed with a linear operation. The full array receiver has knowledge of the complete Rₓ (of its estimate in practice). Each subarray, however, only has incomplete knowledge of the noise color, reflected in a submatrix of covariance Rₓ as described below, so some of the color information is lost on it. Downstream processing captures the partial color information from the subarrays and makes up some of the loss of color information with a less granular version. An averaging effect can smooth over some of the finer color structure and can explain the residual loss.

In some embodiments, the receive antennas can be split into two subsets, A and B, of equal size N/2, which represent two subarrays. Without loss of generality, the subsets can be assumed to be contiguous in the vector notation. The received signal and the channel can be split accordingly

$$r = [ \begin{matrix}{r}_{A} \\ {r}_{B}\end{matrix} ]$$

$$H = [ \begin{matrix}{H}_{A} \\ {H}_{B}\end{matrix} ]$$

$$w = [ \begin{matrix}{w}_{A} \\ {w}_{B}\end{matrix} ]$$

The individual subarray receivers observe their own partial received signals

r_{A}=H_{A}s+w_{A}

r_{B}=H_{B}s+w_{B}

The total covariance can be rewritten as

$${R}_{w} = [ \begin{matrix}{R}_{w A} & {Q}_{w A B} \\ {Q}_{w A B}^{H} & {R}_{w B}\end{matrix} ]$$

where R_{wA} and R_{wB} are the separate covariances of w_{A} and w_{B} respectively, and Q_{wAB} is the cross covariance of w_{A} and w_{B}.

Extrapolating from the original full array receiver, the subarray receiver A can be expected to estimate its own covariance R_{wA}, and similarly for B. So, when A and B join forces downstream, the knowledge of R_{wA} and R_{wB} will be available and can be exploited. The real problem is that neither A nor B can estimate Q_{wAB}, so there is a loss of information compared to the full array receiver.

Subarray receivers for A and B following the same approach as before, with a transform to the signal domain. That is, A observes r_{A} and produces

\tilde{s}_{A}=(H_{A}^{H}R_{wA}⁻¹H_{A})⁻¹H_{A}^{H}R_{wA}⁻¹r_{A}=F_{A}r_{A}=S+F_{A}w_{A}=s+x_{A}

where the previous notation has been modified to refer to subarray A. The covariance of x_{A} can be written as

R_{xA}=F_{A}R_{wA}F_{A}^{H}

which can also be written as

R_{xA}=(H_{A}^{H},R_{wA}⁻¹_{A}H_{A})⁻¹

The structure of the subarray processing is shown in FIG. 4 for subarray A. The signal, r_{A}, received by subarray A can be input to a parameter estimation module 410 and a signal transform module 430. The parameter estimation module 410 can output H_{A} and R_{wA} to a parameter transform module 420, which can output F_{A} to the signal transform module 430. The signal transform module 430 can then output \tilde{s}_{A}.

Similarly, B observes r_{B} and goes through the same steps to produce

\tilde{s}_{B}=s+F_{B}w_{B}=s+x_{B}

and also the matrices F_{B} and R_{xB} (just replacing subscript A with B). The structure of the subarray processing is shown in FIG. 5 for subarray B. The signal, r_{B}, received by subarray B can be input to a parameter estimation module 510 and a signal transform module 530. The parameter estimation module 510 can output H_{B} and R_{wB} to a parameter transform module 520, which can output F_{B} to the signal transform module 530. The signal transform module 530 can then output \tilde{s}_{B}.

A (or B) can be treated as a complete standalone receiver if the last step of the SD, namely the sphere restricted search, is applied to \tilde{s}_{A} to find the best candidate symbol, as well as applying the demapper to find hard or soft values. However, the performance may be limited by the reduced size of the subarray of A (or B).

A and B output \tilde{s}_{A} and \tilde{s}_{B} for downstream processing (along with any other quantity needed such as F_{A}, F_{B}, etc.).

In some embodiments, \tilde{s}_{A} and \tilde{s}_{B} are processed together to improve the overall performance and approach the performance of the full array. In some examples, \tilde{s}_{A} and \tilde{s}_{B} are combined into a new improved estimate \tilde{s}_{comb} which can be input to the sphere restricted search of the SD.

The noise terms x_{A} and x_{B} are correlated, with covariance R_{xAB} that can be estimated based on the information available at the downstream processing phase. The estimated covariance can be used in a similar way as the unconstrained processing or the subarray processing.

In order to combine \tilde{s}_{A} and \tilde{s}_{B} into a single vector of size M, they can be treated as a single received signal with colored noise. To do so, \tilde{s}_{A} and \tilde{s}_{B} can be stacked to get a new channel model,

$${\tilde{s}}_{A B} = [ \begin{matrix}{\tilde{s}}_{A} \\ {\tilde{s}}_{B}\end{matrix} ] = Js + {x}_{A B}$$

where the noise

$${x}_{A B} = [ \begin{matrix}{x}_{A} \\ {x}_{B}\end{matrix} ] = [ \begin{matrix}{F}_{A} {w}_{A} \\ {F}_{B} {w}_{B}\end{matrix} ] = [ \begin{matrix}{F}_{A} & 0 \\ 0 & {F}_{B}\end{matrix} ] w$$

has covariance R_{xAB}. Assuming that

$$G = [ \begin{matrix}{F}_{A} & 0 \\ 0 & {F}_{B}\end{matrix} ]$$

then R_{xAB} can be related to R_{w}, as

R_{xAB}=GR_{w}G^{H}

The special double identity channel

$$J = [ \begin{matrix}I \\ I\end{matrix} ]$$

occurs because the actual channel has already been accounted for in the transformation to the signal domain in the separate subarrays.

In order to combine the elements of \tilde{s}_{AB} into the estimate \tilde{s}_{comb} another transform can be performed using J as the channel model and R_{xAB} as the noise covariance. That is, a transformation matrix is formed

F_{AB}=(J^{H}R_{xAB}⁻¹J)⁻¹J^{H}R_{xAB}⁻¹

and \tilde{s}_{comb} is obtained as

\tilde{s}_{comb}=F_{AB}\tilde{s}_{AB}=s+y_{AB}

of dimension M. The noise term

$${y}_{A B} = {F}_{A B} [ \begin{matrix}{x}_{A} \\ {x}_{B}\end{matrix} ]$$

has covariance

R_{yAB}=F_{AB}R_{xAB}F_{AB}^{H}

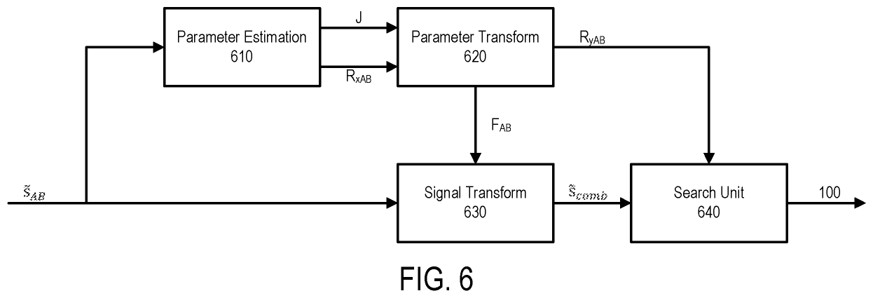

The signal \tilde{s}_{comb} and the covariance R_{yAB} are fed to the sphere restricted search of the SD. The process is shown in FIG. 6. Downstream processing circuitry can receive \tilde{s}_{A} and \tilde{s}_{B} and treat them as a combined signal, \tilde{s}_{AB}, which can be provided to a parameter estimation module 610 and a signal transform module 630. The parameter estimation module 610 can determine J and R_{xAB}, which are output to a parameter transform module 620. The parameter transform module 620 can determine F_{AB}, which is provided to the signal transform module 630 and determine R_{yAB}, which is provided to a search unit 640 (e.g., a sphere restricted search unit). The signal transform module 630 can determine \tilde{s}_{comb}, and provide \tilde{s}_{comb} to the search unit 640. The search unit 640 can determine a processed received signal 600 based on \tilde{s}_{comb} and R_{yAB}, where the processed received signal 600 is more accurate than if \tilde{s}_{A} or \tilde{s}_{B} had been decoded independently.

Recall that R_{xAB}=GR_{w}G^{H}, and that Q_{wAB}, the cross covariance term of R_{w}, cannot be estimated by either subarray processing phases, so it is not available in the downstream processing phase.

With some further manipulations, R_{xAB} can be written as

$${R}_{x A B} = [ \begin{matrix}{R}_{x A} & {Q}_{x A B} \\ {Q}_{x A B}^{H} & {R}_{x B}\end{matrix} ]$$

The matrices R_{xA} and R_{xB} were described earlier and can be estimated in their respective subarray phases. The cross covariance Q_{xAB} can be written as

Q_{xAB}=F_{A}Q_{wAB}F_{B}^{H}

again highlighting the missing submatrix Q_{wAB}.

In order to estimate R_{xAB}, the previously obtained estimates R_{xA} and R_{xB} can be used. Then Q_{xAB} can be estimated directly from the signals \tilde{s}_{A} and \tilde{s}_{B}.

Alternatively, the whole of R_{xAB} can be estimated directly from the stacked signal \tilde{s}_{AB}.

Using the estimate of R_{xAB}, R_{yAB} can be determined, which is needed in the SD.

In some embodiments, estimating R_{xAB}, which is needed in the downstream processing, does not violate the limitation of the subarray constraint. R_{xAB} can be thought of as an averaged version of R_{w} However, Q_{xAB} has a size of M×M, which is smaller than Q_{wAB} of size N/2×N/2, thus some of the fine grained information about the noise color may be irreversibly lost in the averaging due to F_{A} and F_{B}.

In some embodiments, J is assumed to be a double identity matrix. This may only be true if channel parameters are estimated perfectly. In some examples, receivers operate in a range of channel quality where channel parameters are estimated quite well. In some embodiments, J is modeled as a double identity matrix. In which case it is not estimated in the parameter estimation block in FIG. 6. In additional or alternative embodiments, J is estimated by treating \tilde{s}_{AB} as the effective receive signal available in the downstream processing phase. The pilot symbols can be used as discussed above.

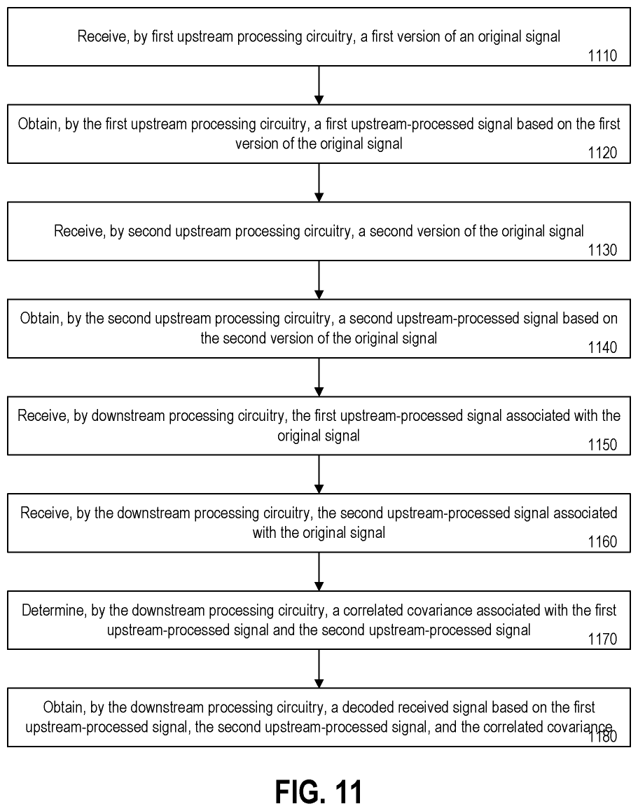

Operations of a network node will now be discussed with reference to the flow charts of FIG. 11 according to some embodiments of inventive concepts. FIG. 11 will be described below as being performed by RAN node 1000 (implemented using the structure of the block diagram of FIG. 10). For example, modules may be stored in memory 1005 of FIG. 10, and these modules may provide instructions so that when the instructions of a module are executed by respective RAN node processing circuitry 1003, processing circuitry 1003 performs respective operations of the flow charts. However, the at least a portion of the operations may be performed by any downstream processing circuitry, downstream receiver, or network node.

FIG. 11 illustrates examples of operations performed by a RAN node 1000 in accordance with some embodiments.

At block 1110, first upstream processing circuitry 1013 receives, via antenna subarray 1030a, a first version of an original signal. In some embodiments, the first version of the original signal is a first receive signal domain representation of the original signal.

At block 1120, first upstream processing circuitry 1013 obtains a first upstream-processed signal based on the first version of the original signal. In some embodiments, the first upstream-processed signal is a transmit signal domain version/representation of a first receive signal domain version of the original signal received at a first receiver 1010 in the RAN node 1000. In additional or alternative embodiments, obtaining the first upstream-processed signal includes transforming the first receive signal domain representation of the original signal to a first transmit signal domain representation of the original signal.

At block 1130, second upstream processing circuitry 1023 receives, via antenna subarray 1030b, a second version of the original signal. In some embodiments, the second version of the original signal is a second receive signal domain representation of the original signal.

At block 1140, second upstream processing circuitry 1023 obtains a second upstream-processed signal based on the second version of the original signal. In some embodiments, the second upstream-processed signal is a transmit signal domain version/representation of a second receive signal domain version of the original signal received at a second receiver 1020 in the RAN node 1000. In additional or alternative embodiments, obtaining the second upstream-processed signal includes transforming the second receive signal domain representation of the original signal to a second transmit signal domain representation of the original signal.

At block 1150, downstream processing circuitry 1003 receives the first upstream-processed signal. In some embodiments, receiving the first upstream-processed signal includes receiving the first upstream-processed signal from the first upstream processing circuitry 1013 in the RAN node 1000. In additional or alternative embodiments, the first upstream-processed signal can be received from a remote receiver independent from the network node.

At block 1160, downstream processing circuitry 1003 receives the second upstream-processed signal. In some embodiments, receiving the second upstream-processed signal includes receiving the second upstream-processed signal from the second upstream processing circuitry 1013 in the RAN node 1000. In additional or alternative embodiments, the second upstream-processed signal can be received from a remote receiver independent from the network node.

At block 1170, downstream processing circuitry 1003 determines a common characteristic (in this example, a covariance) associated with the first upstream-processed signal and the second upstream-processed signal. The common characteristic is determined based on both the first upstream-processed signal and the second upstream-processed signal being associated with the original signal. In some embodiments, the common characteristic includes a correlated covariance.

At block 1180, downstream processing circuitry 1003 obtains a processed received signal based on the first upstream-processed signal, the second upstream-processed signal, and the common characteristic. In some embodiments, obtaining the processed received signal includes performing a maximum likelihood process on the first upstream-processed signal and the second upstream-processed signal using the common characteristic. In additional or alternative embodiments, performing the maximum likelihood process includes sphere decoding the first upstream-processed signal and the second upstream-processed signal using the common characteristic.

In some embodiments, the communication network is a new radio, NR, network.

Various operations of FIG. 11 may be optional with respect to some embodiments of network nodes and related methods.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a network node of a communication network, the method comprising:
receiving, by processing circuitry of the network node, a first upstream-processed signal associated with an original signal;
receiving, by the processing circuitry in the network node, a second upstream-processed signal, associated with the original signal;
determining, by the processing circuitry in the network node, a covariance associated with the first upstream-processed signal and the second upstream-processed signal; and
obtaining, by the processing circuitry in the network node, a processed received signal based on the first upstream-processed signal, the second upstream-processed signal, and the covariance.

2. The method of claim 1, wherein the network node is associated with an array of antennas,
wherein receiving the first upstream-processed signal comprises receiving the first upstream-processed signal from a first receiver associated with a first subarray of the array of antennas, and
wherein receiving the second upstream-processed signal comprises receiving the second upstream-processed signal from a second receiver associated with a second subarray of the array of antennas, the second subarray being distinct from the first subarray.

3. The method of claim 1, wherein the first upstream-processed signal is a transmit signal domain version of a first receive signal domain version of the original signal received at a first receiver in the network node, and
wherein the second upstream-processed signal is a transmit signal domain version of a second receive signal domain version of the original signal received at a second receiver in the network node.

4. The method of claim 1, further comprising: receiving, by a first receiver in the network node, a first version of the original signal;
obtaining, by the first receiver in the network node, the first upstream-processed signal based on the first version of the original signal;
receiving, by a second receiver in the network node, a second version of the original signal;
obtaining, by the second receiver in the network node, the second upstream-processed signal based on the second version of the original signal;

5. The method of claim 4, wherein the network node comprises an antenna array,
wherein the first receiver is associated with a first subarray of the antenna array, and
wherein the second receiver is associated with a second subarray of the antenna array that is distinct of the first subarray.

6. The method of claim 4, wherein the first version of the original signal is a first receive signal domain representation of the original signal,
wherein the second version of the original signal is a second receive signal domain representation of the original signal,
wherein obtaining the first upstream-processed signal comprises transforming the first receive signal domain representation of the original signal to a first transmit signal domain representation of the original signal, and
wherein obtaining the second upstream-processed signal comprises transforming the second receive signal domain representation of the original signal to a second transmit signal domain representation of the original signal.

7. The method of claim 1, wherein obtaining the processed received signal comprises performing a maximum likelihood process on the first upstream-processed signal and the second upstream-processed signal using the covariance.

8. The method of claim 7, wherein performing the maximum likelihood process comprises sphere decoding the first upstream-processed signal and the second upstream-processed signal using the covariance.

9. A network node operating in a communication network, the network node comprising:
processing circuitry; and
memory coupled to the processing circuitry and having instructions stored therein that are executable by the processing circuitry to cause the network node to perform operations, the operations comprising:
receiving a first upstream-processed signal associated with an original signal;
receiving a second upstream-processed signal, associated with the original signal;
determining a covariance associated with the first upstream-processed signal and the second upstream-processed signal; and
obtaining a processed received signal based on the first upstream-processed signal, the second upstream-processed signal, and the covariance.

10. The network node of claim 9, wherein the network node is associated with an array of antennas,
wherein receiving the first upstream-processed signal comprises receiving the first upstream-processed signal from a first receiver associated with a first subarray of the array of antennas, and
wherein receiving the second upstream-processed signal comprises receiving the second upstream-processed signal from a second receiver associated with a second subarray of the array of antennas, the second subarray being distinct from the first subarray.

11. The network node of claim 9, wherein the first upstream-processed signal is a transmit signal domain version of a first receive signal domain version of the original signal received at a first receiver in the network node, and
wherein the second upstream-processed signal is a transmit signal domain version of a second receive signal domain version of the original signal received at a second receiver in the network node.

12. The network node of claim 9, further comprising:
a first receiver comprising:
first upstream processing circuitry; and
first memory coupled to the first upstream processing circuitry and having instructions stored therein that are executable by the first upstream processing circuitry to cause the first receiver to perform first upstream operations, the first upstream operations comprising:
receiving, by the first receiver in the network node, a first version of the original signal; and
obtaining, by the first receiver in the network node, the first upstream-processed signal based on the first version of the original signal; and
a second receiver comprising:
second upstream processing circuitry; and
second memory coupled to the second upstream processing circuitry and having instructions stored therein that are executable by the second upstream processing circuitry to cause the second receiver to perform second upstream operations, the second upstream operations comprising:
receiving, by the second receiver in the network node, a second version of the original signal; and
obtaining, by the second receiver in the network node, the second upstream-processed signal based on the second version of the original signal.

13. The network node of claim 12, further comprising:
an array of antennas comprising a first subarray of antennas and a second subarray of antennas, the second subarray being distinct from the first subarray,
wherein the first receiver is coupled with the first subarray of antennas, and wherein the second receiver is coupled with the second subarray of antennas.

14. The network node of claim 12, wherein the first version of the original signal is a first receive signal domain representation of the original signal,
wherein the second version of the original signal is a second receive signal domain representation of the original signal,
wherein obtaining the first upstream-processed signal comprises transforming the first receive signal domain representation of the original signal to a first transmit signal domain representation of the original signal, and
wherein obtaining the second upstream-processed signal comprises transforming the second receive signal domain representation of the original signal to a second transmit signal domain representation of the original signal.

15. The network node of claim 9, wherein obtaining the processed received signal comprises performing a maximum likelihood process on the first upstream-processed signal and the second upstream-processed signal using the common characteristic.

16. The network node of claim 15, wherein performing the maximum likelihood process comprises sphere decoding the first upstream-processed signal and the second upstream-processed signal using the covariance.

17. (canceled)

18. (canceled)

19. (canceled)

20. (canceled)

21. A computer program product comprising a non-transitory storage medium including program code to be executed by processing circuitry of a network node operating in a communication network, whereby execution of the program code causes the network node to perform operations, the operations comprising:
receiving, by the processing circuitry of the network node, a first upstream-processed signal associated with an original signal;
receiving, by the processing circuitry in the network node, a second upstream-processed signal, associated with the original signal;
determining, by the processing circuitry in the network node, a covariance associated with the first upstream-processed signal and the second upstream-processed signal; and
obtaining, by the processing circuitry in the network node, a processed received signal based on the first upstream-processed signal, the second upstream-processed signal, and the covariance.

22. (canceled)
